(19) United States
(12) Patent Application Publication
(10) Pub. No.: US 2015/0294488 A1
(43) Pub. Date: Oct. 15, 2015

(54) GRAPH GENERATING DEVICE, GRAPH GENERATING METHOD AND GRAPH GENERATING PROGRAM

(71) Applicant: NS SOLUTIONS CORPORATION, Tokyo (JP)

(72) Inventors: Yohei IWASAKI, Tokyo (JP); Hiroaki KIMURA, Tokyo (JP)

(21) Appl. No.: 14/682,713

(22) Filed: Apr. 9, 2015

(30) Foreign Application Priority Data
Apr. 10, 2014 (JP) 081401/2014

(51) Int. Cl. G06T 11/20

(52) U.S. Cl. CPC G06T 11/206

(57) ABSTRACT

A graph generating device which can layout common nodes so as to have the same positional relationship as positional relationship in a graph before updating when content of graph structure data is updated, is provided. In a storage device 30, first graph structure data and layout original data with respect to the first graph structure data are stored. When second graph structure data obtained by updating content of the first graph structure data is input, data updating and registering means 51 stores the second graph structure data in the storage device 30. When a graph corresponding to the second graph structure data is generated, layout position calculating means 52 specifies common nodes described common to the second graph structure data and the first graph structure data with respect to the second graph structure data and performs layout of the graph under the conditions that concerning each of the common nodes, relative positional relationship defined by the layout original data with respect to the first graph structure data is maintained.

### BACKGROUND OF THE INVENTION

1. Field of the Invention

The present invention relates to a graph generating device, a graph generating method and a graph generating program for generating a graph including a plurality of nodes and a plurality of edges connecting the nodes and displaying the graph on a screen of a display device.

2. Description of the Related Art

Conventionally, charts, tables and graphs have been used to facilitate visual confirmation of complicated data. Graphs described here refer to figures for visualizing relationship between data and are distinguished from figures for displaying statistical data, for example, line graphs for indicating temporal change of data or pie graphs or bar graphs for indicating the size relationship between data or percentage of each data with respect to the whole. Further, for example, class diagrams for visualizing design information and a structure of a system, and call graphs for indicating call relationship between sub-routines of a system program which are used in system development, are also included in the graphs described here.

Typically, a graph is comprised of a plurality of nodes and a plurality of edges. A node which is a point indicating data, is generally expressed using a graphic having a size on the graph. An edge which is a side connecting the nodes, is expressed using a straight line or a polygonal line on the graph. A graph is desired to be generated such that a plurality of nodes and a plurality of edges are laid out so as to make it easier for a user to recognize the structure of the graph. Therefore, when, for example, a directed graph including directional edges is generated, it is necessary to lay out a plurality of nodes and a plurality of edges so as to satisfy conditions that “edges should be unidirectional”, “length of edges should be shortest”, “intersection number of edges should be smallest”, “edges should be vertical” and “nodes should be consistent” as far as possible. Here, “edges should be unidirectional” means that layout is performed so that the edges face in the same direction, “length of edges should be shortest” means that layout is performed so that length of each edge becomes as short as possible, “intersection number of edges should be smallest” means that layout is performed so that the number of edges which intersect with each other becomes as small as possible, “edges should be vertical” means that each edge is expressed with not a polygonal line but a straight line, and “nodes should be consistent” means that layout is performed so that a single node only appears at one location within the graph instead of appearing at a plurality of locations.

While it is possible to manually lay out a plurality of nodes and a plurality of edges so as to satisfy the above-described conditions for a small-scale graph, it is difficult to manually lay out a plurality of nodes and a plurality of edges for a large-scale graph including a large number of nodes and a large number of edges. Therefore, today, a technique is proposed which utilizes a computer to automatically perform layout of a graph so as to satisfy the above-described conditions as far as possible (for example, see Patent Literatures 1 and 2). In this case, layout of a graph is performed according to a graph layout algorithm. While various algorithms can be used as such a graph layout algorithm, particularly, Sugiyama algorithm is widely known in a field of hierarchical layout of a directed graph (for example, see Non-Patent Literatures 1 and 2). A summary of Sugiyama algorithm will be described below.

Sugiyama algorithm is an algorithm for performing hierarchical layout of a directed graph. Sugiyama algorithm assumes a directed acyclic graph as a directed graph. FIG. 14 is a diagram for explaining Sugiyama algorithm. As illustrated in FIG. 14, Sugiyama algorithm is comprised of three steps: a first step for assigning hierarchy (hierarchy assigning step), a second step for ordering nodes (ordering step) and a third step for providing a position coordinate (horizontal coordinate assignment step).

First, in the first step, hierarchy for which each node should be placed is assigned to each node so as to satisfy conditions that length of edges should be shortest, that nodes should be consistent, or the like, as far as possible based on graph structure data. Here, the graph structure data includes data indicating a shape and a size of each node (node data) and data indicating connection relationship to nodes for each edge (edge data). This graph structure data is input in advance to a computer. Next, in the second step, in each hierarchy, order for placing nodes to which the hierarchy has been assigned is determined so as to satisfy conditions that edges should be unidirectional, that intersection number of edges should be smallest, or the like, as far as possible. In the third step, a position of each node is determined so as to satisfy conditions that edges should be vertical as far as possible, and information (position coordinate) as to the position is provided to the node. When the position coordinate of each node is determined as described above, the computer can generate a directed graph based on data as to the position coordinate of each node and the graph structure data and can display the directed graph on a screen of a display device.

While Sugiyama algorithm assumes a directed acyclic graph as a directed graph for which layout is to be performed, there is also a case where a directed graph for which layout is to be actually performed is a directed cyclic graph. When layout of a directed cyclic graph is performed using Sugiyama algorithm, it is necessary to perform cycle remove processing prior to the processing of the above-described three steps. In this cycle remove processing, graph structure data for a directed acyclic graph is created by “inverting” edges (exchanging a starting point of an edge with an end point) or “eliminating” the edges in the graph structure data for the directed cyclic graph. The created graph structure data is subjected to processing of the above-described three steps to perform layout of the graph. Finally, a directed cyclic graph is generated by restoring the edges which has been “inverted” or “eliminated”.

### CITATION LIST

### Patent Literature

Patent Literature 1: Japanese Unexamined Patent Application Publication No. 2002-312803

Patent Literature 2: Japanese Unexamined Patent Application Publication No. 2005-323109

### Non-Patent Literature

Non-Patent Literature 1: Kozo Sugiyama, Shojiro Tagawa and Mitsuhiko Toda, “Methods for visual understanding of hierarchical system structures”, IEEE Trans. on Systems, Man, and Cybernetics, vol. SMC-11, no. 2, pp. 109-125, 1981

Non-Patent Literature 2: Hugo A. D. do Nasciment and Peter Eades, “User Hints for Directed Graph Drawing”, Graph Drawing, pp. 205-219, 2001

### SUMMARY OF THE INVENTION

### Problems to be Solved by the Invention

When a user looks at a graph generated by utilizing a computer, the user sometimes desires to modify, for example, positions where nodes are laid out, connection relationship of edges, or the like. In this case, the user can give an instruction to change the layout of the generated graph displayed on a screen of a display device using an input device. Specifically, the user can manually modify positions where nodes are laid out, or the like, in the graph displayed on the screen of the display device using the input device, or can input rules of lay outing to be applied to positions where nodes are laid out (for example, conditions that designate hierarchy in which a given node should be disposed, conditions that designate hierarchical relationship between two nodes, or the like). The computer executes layout of the graph according to the instruction to change the layout, and thus the graph is modified.

Further, when a node is newly added or an unnecessary node is eliminated from a graph which has been once generated, the user can input new graph structure data by giving an instruction to update content of the graph structure data corresponding to the graph using the input device. Here, “giving an instruction to update content of the graph structure data” includes a case where the user gives an instruction to add or eliminate a node or an edge or modify connection relationship of edges in the graph displayed on the screen of the display device using the input device as well as a case where the user directly inputs graph structure data. When such an instruction is given, the computer generates new graph structure data reflecting the content of the instruction. The computer then performs processing again according to the graph layout algorithm based on the new graph structure data to generate a graph.

Hereinafter, giving an instruction to update the content of the graph structure data corresponding to the generated graph will be referred to as “updating” of data, while giving an instruction to change layout of the generated graph, which is different from updating of data, will be referred to as “change” of layout. It is possible to generate a graph which has been given by applying modification to the generated graph (modified graph) either through updating of data or change of layout. It should be noted that, as described above, typically, concerning addition or elimination of a node or an edge, when a node or an edge is added or eliminated or connection relationship of edges is modified in the generated graph, the computer generates new graph structure data, and thus the modified graph is generated through updating of data, on the other hand, it is also possible to generate the modified graph through change of layout by inputting constraints indicating restrictions for addition or elimination of a node or an edge.

When a graph is modified, if the user inputs new graph structure data through updating of data, the computer performs processing again according to the graph layout algorithm based on the input updated graph structure data to generate a graph. However, if the content of the graph structure data is updated in this way, because the computer executes the same processing as that performed upon generation of a graph before updating from the beginning to newly generate the updated graph, it is often the case that positional relationship between nodes other than a node added or eliminated through updating (common nodes) in the graph for which data has been updated is not the same as the positional relationship in the graph before data has been updated. There is therefore a problem that, to dispose the common nodes to have the same positional relationship as that in the graph before data has been updated, it is necessary to change the layout of the graph for which data has been updated, which is troublesome. Further, there is a problem that when a graph including a huge numbers of nodes is modified, if processing according to the graph layout algorithm is executed from the beginning based on the updated graph structure data, processing load of the computer becomes large.

The present invention has been made in view of the above-described circumstances, and an object of the present invention is to provide a graph generating device, a graph generating method and a graph generating program capable of, when content of graph structure data is updated, easily generating a graph for which data has been updated and performing layout so as to have the same positional relationship of common nodes as that of a graph before data has been updated.

### Means of Solving the Problems

A graph generating device according to the present invention to achieve the above-described object is a graph generating device which generates a graph including a plurality of nodes and a plurality of edges connecting the nodes based on graph structure data including data indicating a shape and a size of each node and data indicating connection relationship to the nodes for each edge, and displays the graph on a screen of a display unit, and the graph generating device includes a storage unit in which the graph structure data corresponding to the generated graph is stored as first graph structure data and layout original data including data relating to a layout position of each node described in the first graph structure data is stored, the layout original data being generated when processing according to a predetermined graph layout algorithm is executed based on the first graph structure data for generating the graph, a data updating and registering unit that, when a user gives an instruction to update content of the first graph structure data corresponding to the generated graph using an input unit, stores and registers the new graph structure data reflecting content of the instructed updating as second graph structure data with respect to the first graph structure data, a layout position calculating unit that specifies nodes described common to the second graph structure data registered by the data updating and registering unit and the first graph structure data with respect to the second graph structure data as common nodes and calculates a layout position of each node described in the second graph structure data by executing processing according to the graph layout algorithm based on the second graph structure data under the conditions that concerning each of the specified common nodes, relative positional relationship defined by the layout original data including data relating to the layout position of each node described in the first graph structure data is maintained, a layout original data generating unit that generates the layout original data including data relating to the layout position of each node described in the second graph structure data, the layout position of each node being calculated by the layout position calculating unit, and stores the generated layout original data in the storage unit as layout original data after updating with respect to the second graph structure data, and a graph display processing unit that generates a graph based on the layout original data after updating and the second graph structure data with respect to the layout original data after updating and displays the graph on the screen of the display unit.

According to the above-described configuration, the graph generating device according to the present invention, when a graph for which data has been updated is generated, specifies nodes described common to the second graph structure data and the first graph structure data with respect to the second graph structure data as common nodes and performs layout of the graph by executing processing according to the predetermined graph layout algorithm based on the second graph structure data under the conditions that concerning each of the specified common nodes, relative positional relationship defined by the layout original data for the generated graph corresponding to the first graph structure data is maintained. Therefore, a position of each common node to be laid out on the graph can be easily determined based on the layout original data for the generated graph, so that it is possible to substantially reduce load of the processing when generating a graph for which data has been updated. Moreover, in this graph for which data has been updated, each of the common nodes can be laid out so as to have the same positional relationship as the positional relationship in the generated graph.

Further, it is preferable that the graph generating device according to the present invention further includes a layout changing unit that, when the user gives an instruction to change layout of the graph displayed on the screen of the display unit using the input unit, generates change data indicating content of the instructed change, stores the change data in the storage unit in association with the graph structure data corresponding to the graph, generates a graph for which the layout has been changed according to the instruction of the change and displays the generated graph on the screen of the display unit. By this means, because the change data can be utilized in processing such as undo processing, when, for example, the generated graph is restored once through processing such as undo processing from the graph for which the layout has been changed and the same change is applied again, it is possible to reflect the change on the graph by utilizing this change data.

Further, it is preferable that in the graph generating device according to the present invention, when the change data has been generated, the layout changing unit calculates a layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result. By this means, when the user gives an instruction to change the layout of the graph displayed on the screen of the display unit, if the change of the layout has been applied to the graph in the past, the layout changing unit reads out all the change data indicating the content of the change applied in the past in addition to the change data indicating the content of the change this time, and executes processing according to the predetermined graph layout algorithm under the conditions that the change of the content indicated by all the read change data is applied. Therefore, the user can easily obtain a graph reflecting the change of the layout applied in the past in addition to the change of the layout this time.

Further, it is preferable that in the graph generating device according to the present invention, when it is judged that as a result of generating the graph for which the layout has been changed according to the instruction of the change from the user, the graph structure data corresponding to the graph for which the layout has been changed differs from the graph structure data corresponding to the graph before the layout has been changed, the layout changing unit newly generates the graph structure data corresponding to the graph for which the layout has been changed and stores the newly generated graph structure data in the storage unit as the first graph structure data. By this means, when the layout is changed, if the graph structure data corresponding to the graph for which the layout has been changed differs from the graph structure data corresponding to the graph before the layout has been changed, because the layout changing unit can automatically generate the graph structure data corresponding to the latest graph after the layout has been changed, the user does not have to update the content of the graph structure data.

A graph generating method according to the present invention to achieve the above-described object is a graph generating method for generating a graph including a plurality of nodes and a plurality of edges connecting the nodes based on graph structure data including data indicating a shape and a size of each node and data indicating connection relationship to the nodes for each edge by utilizing a computer, and displaying the graph on a screen of a display unit of the computer, when the computer includes a storage unit in which the graph structure data corresponding to the generated graph is stored as first graph structure data and layout original data including data relating to a layout position of each node described in the first graph structure data is stored, the layout original data being generated when processing according to a predetermined graph layout algorithm is executed based on the first graph structure data for generating the graph, and a control unit that performs processing for generating the graph, the graph generating method including a data updating and registering step of, when a user gives an instruction to update content of the first graph structure data corresponding to the generated graph using an input unit of the computer, the control unit storing and registering the new graph structure data reflecting content of the instructed updating in the storage unit as second graph structure data with respect to the first graph structure data, a layout position calculating step of the control unit specifying nodes described common to the second graph structure data registered in the data updating and registering step and the first graph structure data with respect to the second graph structure data as common nodes, and calculating a layout position of each node described in the second graph structure data by executing processing according to the graph layout algorithm based on the second graph structure data under the conditions that concerning each of the specified common nodes, relative positional relationship defined by the layout original data including data relating to the layout position of each node described in the first graph structure data is maintained, a layout original data generating step of the control unit generating the layout original data including data relating to the layout position of each node described in the second graph structure data, the layout position of each node being calculated in the layout position calculating step, and storing the generated layout original data in the storage unit as layout original data after updating with respect to the second graph structure data, and a graph display processing step of the control unit generating a graph based on the layout original data after updating and the second graph structure data with respect to the layout original data after updating and displaying the graph on the screen of the display unit.

According to the above-described configuration, in the graph generating method according to the present invention, when a graph for which data has been updated is generated, the control unit of the computer specifies nodes described common to the second graph structure data and the first graph structure data with respect to the second graph structure data as common nodes and performs layout of the graph by executing processing according to the predetermined graph layout algorithm based on the second graph structure data under the conditions that concerning each of the specified common nodes, relative positional relationship defined by the layout original data for the generated graph corresponding to the first graph structure data is maintained. Therefore, a position of each common node to be laid out on the graph can be easily determined based on the layout original data for the generated graph, so that it is possible to substantially reduce load of the processing when generating a graph for which data has been updated. Moreover, in this graph for which data has been updated, each of the common nodes can be laid out so as to have the same positional relationship as the positional relationship in the generated graph.

Further, it is preferable that the graph generating method according to the present invention further includes a layout changing step of, when the user gives an instruction to change layout of the graph displayed on the screen of the display unit using the input unit, the control unit generating change data indicating content of the instructed change, storing the change data in the storage unit in association with the graph structure data corresponding to the graph, generating a graph for which the layout has been changed according to the instruction of the change and displaying the generated graph on the screen of the display unit. By this means, because the change data can be utilized in processing such as undo processing, when, for example, the generated graph is restored once through processing such as undo processing from the graph for which the layout has been changed and the same change is applied again, it is possible to reflect the change on the graph by utilizing this change data.

Further, it is preferable that in the graph generating method according to the present invention, in the layout changing step, when the change data has been generated, the control unit calculates a layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result. By this means, the user can easily obtain a graph reflecting the change of the layout applied in the past in addition to the change of the layout this time.

Further, it is preferable that in the graph generating method according to the present invention, in the layout changing step, when the control unit judges that as a result of generating the graph for which the layout has been changed according to the instruction of the change from the user, the graph structure data corresponding to the graph for which the layout has been changed differs from the graph structure data corresponding to the graph before the layout has been changed, the control unit newly generates the graph structure data corresponding to the graph for which the layout has been changed and stores the newly generated graph structure data in the storage unit as the first graph structure data. By this means, when the layout is changed, if the graph structure data corresponding to the graph for which the layout has been changed differs from the graph structure data corresponding to the graph before the layout has been changed, because the control unit can automatically generate the graph structure data corresponding to the latest graph after the layout has been changed, the user does not have to update the content of the graph structure data.

A graph generating program according to the present invention to achieve the above-described object is a graph generating program for generating a graph including a plurality of nodes and a plurality of edges connecting the nodes based on graph structure data including data indicating a shape and a size of each node and data indicating connection relationship to the nodes for each edge by utilizing a computer, and displaying the graph on a screen of a display unit of the computer, when the computer includes a storage unit in which the graph structure data corresponding to the generated graph is stored as first graph structure data and layout original data including data relating to a layout position of each node described in the first graph structure data is stored, the layout original data being generated when processing according to a predetermined graph layout algorithm is executed based on the first graph structure data for generating the graph, the graph generating program causing the computer to implement a data updating and registering function of, when a user gives an instruction to update content of the first graph structure data corresponding to the generated graph using an input unit of the computer, storing and registering the new graph structure data reflecting content of the instructed updating in the storage unit as second graph structure data with respect to the first graph structure data, a layout position calculating function of specifying nodes described common to the second graph structure data registered by the data updating and registering function and the first graph structure data with respect to the second graph structure data as common nodes, and calculating a layout position of each node described in the second graph structure data by executing processing according to the graph layout algorithm based on the second graph structure data under the conditions that concerning each of the specified common nodes, relative positional relationship defined by the layout original data including data relating to the layout position of each node described in the first graph structure data is maintained, a layout original data generating function of generating the layout original data including data relating to the layout position of each node described in the second graph structure data, the layout position of each node being calculated by the layout position calculating function, and storing the generated layout original data in the storage unit as layout original data after updating with respect to the second graph structure data, and a graph display processing function of generating a graph based on the layout original data after updating and the second graph structure data with respect to the layout original data after updating and displaying the graph on the screen of the display unit.

By applying the graph generating program according to the present invention to the computer, when a graph for which data has been updated is generated, the computer specifies nodes described common to the second graph structure data and the first graph structure data with respect to the second graph structure data as common nodes and performs layout of the graph by executing processing according to the predetermined graph layout algorithm based on the second graph structure data under the conditions that concerning each of the specified common nodes, relative positional relationship defined by the layout original data for the generated graph corresponding to the first graph structure data is maintained. Therefore, a position of each common node to be laid out on the graph can be easily determined based on the layout original data for the generated graph, so that it is possible to substantially reduce load of the processing when generating a graph for which data has been updated. Moreover, in this graph for which the data has been updated, each of common nodes can be laid out so as to have the same positional relationship as the positional relationship in the generated graph.

Further, it is preferable that the graph generating program according to the present invention causes the computer to further implement a layout changing function of, when the user gives an instruction to change layout of the graph displayed on the screen of the display unit using an input unit, generating change data indicating content of the instructed change, storing the change data in the storage unit in association with the graph structure data corresponding to the graph, generating a graph for which the layout has been changed according to the instruction of change and displaying the generated graph on the screen of the display unit. By this means, because the change data can be utilized in processing such as undo processing, when, for example, the generated graph is restored once through processing such as undo processing from the graph for which the layout has been changed and the same change is applied again, it is possible to reflect the change on the graph by utilizing this change data.

Further, it is preferable that in the graph generating program according to the present invention, when the change data has been generated, the layout changing function calculates the layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result. By this means, the user can easily obtain a graph reflecting the change of the layout applied in the past in addition to the change of the layout this time.

Further, it is preferable that in the graph generating program according to the present invention, when it is judged that as a result of generating the graph for which the layout has been changed according to the instruction of the change from the user, the graph structure data corresponding to the graph for which the layout has been changed differs from the graph structure data corresponding to the graph before the layout has been changed, the layout changing function newly generates the graph structure data corresponding to the graph for which the layout has been changed and stores the newly generated graph structure data in the storage unit as the first graph structure data. By this means, when the layout is changed, if the graph structure data corresponding to the graph for which the layout has been changed differs from the graph structure data corresponding to the graph before the layout has been changed, because the computer can automatically generate the graph structure data corresponding to the latest graph after the layout has been changed, the user does not have to update the content of the graph structure data.

### Effects of the Invention

According to the graph generating device, the graph generating method and the graph generating program according to the present invention, when a graph for which data has been updated is generated, positions of common nodes described common to the second graph structure data and the first graph structure data with respect to the second graph structure data, to be laid out on the graph can be easily determined based on the layout original data for the generated graph corresponding to the first graph structure data, so that it is possible to substantially reduce load of processing for generating a graph for which data has been updated. Moreover, in this graph for which data has been updated, each of the common nodes can be laid out so as to have the same positional relationship as the positional relationship in the generated graph.

### BRIEF DESCRIPTION OF THE DRAWINGS

FIG. 1 is a schematic block diagram of a graph generating device according to one embodiment of the present invention;

FIG. 2 is a diagram illustrating an example of graph structure data;

FIG. 3 is a diagram illustrating an example of layout original data with respect to the graph structure data in FIG. 2;

FIG. 4 is a flowchart for explaining procedure of processing of generating a graph based on first graph structure data and displaying the graph on a screen of a display device in the graph generating device of the present embodiment;

FIG. 5 is a diagram illustrating a graph generated based on the layout original data in FIG. 3 and the first graph structure data in FIG. 2;

FIG. 6 is a flowchart for explaining procedure of processing of generating a graph based on second graph structure data and displaying the graph on the screen of the display device in the graph generating device of the present embodiment;

FIG. 7 is a diagram illustrating an example of the second graph structure data with respect to the first graph structure data in FIG. 2;

FIG. 8 is a diagram illustrating an example of modified edge data which has been modified by layout position calculating means;

FIG. 9(a) is a diagram illustrating hierarchy of each of nodes determined when the layout position calculating means performs processing according to a hierarchy assigning step;

FIG. 9(b) is a diagram illustrating hierarchy of each of nodes and the order within the hierarchy determined when the layout position calculating means performs processing according to an ordering step;

FIG. 10 is a diagram illustrating an example of layout original data with respect to the second graph structure data in FIG. 7;

FIG. 11 is a diagram illustrating a graph generated based on the layout original data in FIG. 10 and the second graph structure data in FIG. 7;

FIG. 12 is a diagram illustrating a graph generated by executing processing according to Sugiyama algorithm based on the graph structure data in FIG. 7 using a conventional graph generating device;

FIG. 13 is a flowchart for explaining procedure of processing of generating a graph when an instruction to change layout is given and displaying the graph on the screen of the display device in the graph generating device of the present embodiment; and

FIG. 14 is a diagram for explaining Sugiyama algorithm.

### DESCRIPTION OF THE EMBODIMENTS

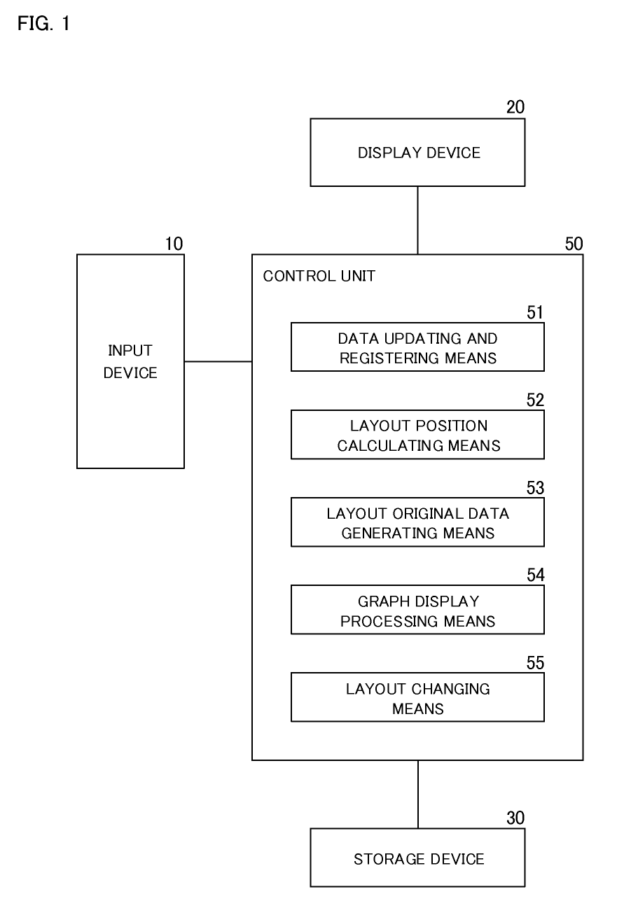

An embodiment for implementing an invention according to the present application will be described below with reference to the drawings. FIG. 1 is a schematic block diagram of a graph generating device according to one embodiment of the present invention.

The graph generating device according to the present embodiment which generates a graph including a plurality of nodes and a plurality of edges connecting the nodes and displays the graph on a screen, includes, as illustrated in FIG. 1, an input device 10, a display device 20, a storage device 30 and a control unit 50. This graph generating device is implemented with, for example, a personal computer.

The input device (input means) 10 is, for example, used to input various instructions and data. As this input device 10, a keyboard, a mouse, or the like is used. For example, a user uses the input device 10 to input graph structure data required for generating a graph. Further, the user can give an instruction to update content (updating of data) of graph structure data corresponding to the generated graph, or give an instruction to change layout (change of layout) of the generated graph using the input device 10. The generated graph can be modified by updating data or changing layout as described above. The display device (display means) 20 is used to display a graph generated by the control unit 50.

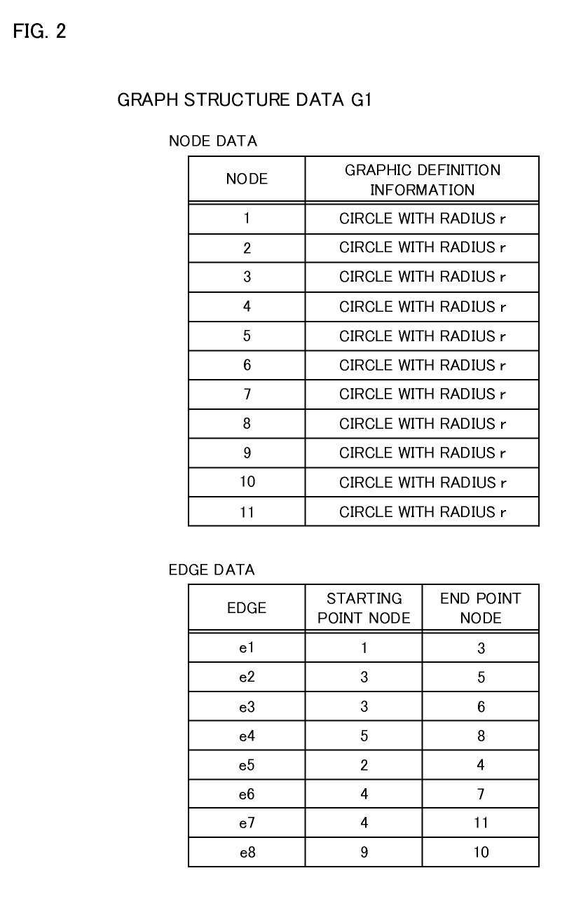

In the storage device (storage means) 30, various data, specifically, graph structure data, layout original data, change data, and the like, are stored. The graph structure data is input by the user using the input device 10. A graph is generated based on this graph structure data. In the present embodiment, explanation will be provided assuming a case where the graph structure data is intended for a directed acyclic graph. FIG. 2 is a diagram illustrating an example of the graph structure data. As illustrated in FIG. 2, this graph structure data includes node data and edge data. The node data indicates a shape and a size (graphic definition information) of each node. For example, when a certain node located on the graph is expressed with a circle, the graphic definition information for this node includes content indicating that the node has a shape of a circle and a radius of the circle. Further, when a certain node is expressed with a rectangle, the graphic definition information for this node includes content indicating that the node has a shape of a rectangle and vertical length and horizontal length of the rectangle. The edge data indicates connection relationship to the nodes for each edge. An edge in a directed graph has a direction, which is specified as a direction from a starting point toward an end point of the edge. Specifically, the edge data for each edge includes data specifying a node connected to the starting point of the edge (starting point node) and a node connected to the end point of the edge (end point node). Further, an identification ID is provided to the graph structure data. Because a graph is generated based on the graph structure data, the identification ID provided to the graph structure data is also used to identify the graph.

In the present embodiment, the graph structure data which is separated into first graph structure data and second graph structure data, is managed. Specifically, the graph structure data corresponding to the generated graph is stored in the storage device 30 as the first graph structure data. While the user can update data by giving an instruction to update content of the first graph structure data, new graph structure data reflecting content of the instructed updating is stored in the storage device 30 as the second graph structure data. That is, the first graph structure data is graph structure data corresponding to the graph before data has been updated (graph structure data before updating), while the second graph structure data is graph structure data corresponding to the graph after data has been updated (graph structure data after updating). The first graph structure data and the second graph structure data are associated with each other. For example, it is possible to associate the first graph structure data with the second graph structure data by providing the same identification ID as that provided to the first graph structure data to the second graph structure data. Further, whether given graph structure data is the first graph structure data or the second graph structure data can be distinguished using, for example, an ID or a flag. Further, when the control unit 50 generates a graph for which data has been updated based on the second graph structure data and displays the graph on the screen of the display device 20, the second graph structure data is managed as the first graph structure data. It should be noted that if graph structure data is newly input and a graph has not been generated yet based on this graph structure data, this graph structure data is also dealt as the first graph structure data, not the second graph structure data. Further, it is also possible to employ a configuration in which when data has been updated, only the second graph structure data which is the latest graph structure data is maintained after the updating.

The layout original data is generated when the control unit 50 executes processing according to a predetermined graph layout algorithm based on graph structure data for generating a graph. The layout original data includes data relating to a layout position of each node described in the graph structure data. Particularly, layout original data which includes data relating to a layout position of each node described in the first graph structure data will be also referred to as layout original data before updating with respect to the first graph structure data, while layout original data which includes data relating to a layout position of each node described in the second graph structure data will be also referred to as layout original data after updating with respect to the second graph structure data. The layout original data is stored in the storage device 30 in association with the graph structure data used for generating the layout original data. The layout original data can be associated with the graph structure data using various methods. For example, the layout original data may be directly linked to the graph structure data. Alternatively, it is also possible to associate the layout original data with the graph structure data by providing the same identification ID as that provided to the graph structure data to be associated with to the layout original data.

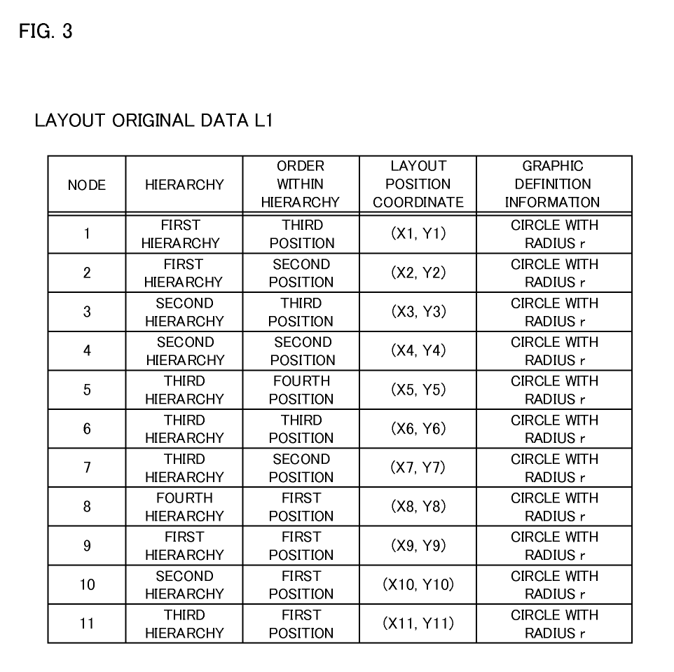

In the present embodiment, because the graph structure data is intended for a directed graph, an algorithm for performing hierarchical layout of a directed graph, specifically, Sugiyama algorithm is used as the above-described graph layout algorithm. FIG. 3 is a diagram illustrating an example of the layout original data with respect to the graph structure data in FIG. 2. As illustrated in FIG. 3, the layout original data includes data for each node such as hierarchy assigned to the node, an order for disposing the node within the hierarchy (order within the hierarchy), a layout position coordinate (data relating to the layout position) and graphic definition information. Actually, only the layout position coordinate of each node and the graph structure data are required for generating a graph. In the present embodiment, to make the feature of the present invention easily understood, the layout original data also includes the hierarchy, the order within the hierarchy and the graphic definition information in addition to the layout position coordinate. It is therefore only necessary for the layout original data to include at least the layout position coordinate for each node.

In the graph generating device of the present embodiment, it is possible to modify a graph using a method for changing layout separately from a method for updating data. Change data is generated when the user gives an instruction to change the layout of the graph. This change data indicates content of the instructed change. Specifically, the change data is generated by the control unit 50 when the user gives an instruction to, for example, change the layout position of a node in the graph displayed on the screen of the display device 20 using the input device 10. At this time, this change data includes data relating to the layout position of the node after change, or the like. Particularly, when a graph is modified by adding or eliminating nodes or edges or changing connection relationship of edges, the graph can be modified using a method for changing the layout in addition to using a method for updating data, through inputting of constraints indicating restrictions to addition or elimination of nodes or edges or constraints indicating restrictions to change of connection relationship of edges. Therefore, the change data may include constraints indicating restrictions to addition or elimination of nodes or edges or constraints indicating restrictions to change of connection relationship of edges.

Further, the change data is stored in the storage device 30 in association with the graph structure data corresponding to the graph before the layout has been changed, displayed on the screen when the user gives an instruction for the change. Because the graph is generated based on the graph structure data, it can be also considered that the change data is associated with the graph before the change. The change data can be associated with the graph structure data using various methods. For example, the change data may be directly linked to the graph structure data. Further, it is also possible to associate the change data with the graph structure data by providing the same identification ID as the identification ID provided to the graph structure data to be associated with to the changed data. Further, when the layout of a given graph has been changed a plurality of times, the same identification ID is provided to each of the change data generated when change is performed each time. Here, it is also possible to provide sequence numbers for specifying an order of the change to these plurality of change data. In this way, there is also a case where a plurality of change data may be associated with given graph structure data. It should be noted that when the layout of a given graph has been changed a plurality of times, if the content of all the change can be aggregated as one of change data, it is also possible to associate the aggregated change data with the graph structure data corresponding to the graph.

Further, various programs for causing the control unit 50 to execute predetermined processing are stored in the storage device 30. For example, a program for calculating a layout position of each node by performing processing according to Sugiyama algorithm, a program for generating a graph based on the graph structure data and the layout original data, a program for displaying the generated graph on the screen of the display device 20, and the like, are stored in the storage device 30.

The control unit (control means) 50 manages and controls each unit of the present device. As illustrated in FIG. 1, the control unit 50 includes data updating and registering means 51, layout position calculating means 52, layout original data generating means 53, graph display processing means 54 and layout changing means 55. The control unit 50 performs processing of modifying the generated graph as well as generates a new graph based on new graph structure data and displays the graph on the screen of the display device 20.

Specifically, the graph generating device of the present embodiment has a graph modifying function through updating of data, and a graph modifying function through change of layout as functions for modifying the generated graph. As described above, updating of data indicates that the user gives an instruction to update content of the graph structure data corresponding to the generated graph, while change of layout indicates that the user gives an instruction to change the layout of the generated graph. The graph modifying function through updating of data is implemented by the data updating and registering means 51, the layout position calculating means 52, the layout original data generating means 53 and the graph display processing means 54, while the graph modifying function through change of data is implemented by the layout changing means 55. It should be noted that a function for generating a new graph is implemented by the layout position calculating means 52, the layout original data generating means 53 and the graph display processing means 54.

When the user gives an instruction to change layout of a graph using the graph modifying function through change of layout, a graph for which the layout has been changed according to the instruction is generated. In this case, the generated modified graph has layout principally as instructed by the user. Meanwhile, when the user gives an instruction to update content of the graph structure data using the graph modifying function through updating of data, because a graph is generated based on new graph structure data having content of the instructed updating, there is a case where the layout of the graph for which data has been updated substantially differs from the layout of the graph before the data has been updated. However, when the graph is modified through updating of data, the user generally wants to obtain a graph after the data has been updated in which nodes other than nodes added or deleted by the updating (common nodes) are disposed to have the same positional relationship as that in the graph before the data has been updated. Therefore, in the present embodiment, as will be described later, the graph modifying function through updating of data is a function which is capable of modifying a graph so that the common nodes are laid out to have the same positional relationship as the positional relationship in the graph before the data has been updated.

When the user gives an instruction to update content of the first graph structure data corresponding to the generated graph using the input device 10, the data updating and registering means 51 stores and registers new graph structure data reflecting content of the instructed updating in the storage device 30 as the second graph structure data with respect to the first graph structure data. Specifically, when the user inputs new graph structure data for which nodes or edges have been added to and/or eliminated from given first graph structure data stored in the storage device 30 using the input device 10, the data updating and registering means 51 stores the input new graph structure data in the storage device 30 as the second graph structure data in association with the first graph structure data. Here, nodes (or edges) which are not targets for addition or elimination are nodes (or edges) described common to the second graph structure data and the first graph structure data associated with the second graph structure data. Nodes (or edges) which are targets of addition are nodes (or edges) described in the second graph structure data but not described in the first graph structure data associated with the second graph structure data, while nodes (or edges) which are targets of elimination are nodes (or edges) not described in the second graph structure data but described in the first graph structure data associated with the second graph structure data. Further, the user can give an instruction to add or eliminate nodes or edges or modify connection relationship of edges using the input device 10 in the graph displayed on the screen of the display device 20 as an instruction for updating content of the first graph structure data corresponding to the generated graph. In this case, the data updating and registering means 51 generates new graph structure data reflecting content of the instruction by adding or eliminating nodes or edges or modifying connection relationship of edges according to the instruction, and stores and registers the generated new graph structure data in the storage device 30 as the second graph structure data.

Specifically, to update and register graph structure data, for example, the user clicks on a predetermined updating button in a state where the graph is displayed on the screen of the display device 20. In response to click operation, an entry screen for graph structure data is displayed, and the user newly inputs graph structure data on the entry screen. When the user finishes inputting the graph structure data and clicks on a predetermined updating and registering button, the data updating and registering means 51 stores the input graph structure data as the second graph structure data in the storage device 30 in association with the first graph structure data which is used when the graph currently displayed on the screen of the display device 20 is generated.

It should be noted that there are various method for updating and registering graph structure data, other than the above-described method. For example, it is also possible to use a method in which the user selects desired first graph structure data among the first graph structure data stored in the storage device 30 and modifies content of the selected first graph structure data, and, when the user finishes modifying the selected first graph structure data and clicks on the predetermined updating and registering button, the data updating and registering means 51 stores the graph structure data for which the content has been modified as the second graph structure data in the storage device 30 in association with the selected first graph structure data. Further, there is also a method in which graph structure data is updated and registered by utilizing a graph. That is, in this method, first, the user gives an instruction to change layout by manually adding or eliminating nodes or edges or modifying connection relationship of edges in the graph displayed on the screen of the display device 20 using the input device 10, and, when the user clicks on the predetermined updating and registering button, the data updating and registering means 51 automatically generates graph structure data reflecting the content of the instruction and stores the generated graph structure data as the second graph structure data in the storage device 30 in association with the first graph structure data corresponding to the graph.

When receiving an instruction to generate a graph based on the first graph structure data, the layout position calculating means 52 calculates a layout position of each node described in the first graph structure data by executing processing according to Sugiyama algorithm based on the first graph structure data. Further, when receiving an instruction to generate a graph based on the second graph structure data, the layout position calculating means 52 specifies nodes described common to the second graph structure data and the first graph structure data with respect to the second graph structure data as common nodes and calculates a layout position of each node described in the second graph structure data by executing processing according to Sugiyama algorithm based on the second graph structure data under the conditions that concerning each of the specified common nodes, relative positional relationship defined by the layout original data (layout original data before updating) stored in the storage device 30 in association with the first graph structure data is maintained. Therefore, if a graph corresponding to the second graph structure data is generated, the common nodes are laid out to have the same positional relationship as the positional relationship in the graph before the data has been updated. Data relating to the layout position of each node (layout position coordinate) calculated by the layout position calculating means is temporarily stored in a RAM embedded within the control unit 50.

The layout original data generating means 53 generates layout original data including the layout position coordinate of each node calculated by the layout position calculating means 52 and stores the generated layout original data in the storage device 30 in association with the graph structure data with respect to the generated layout original data. Particularly, when the layout position calculating means 52 calculates the layout position of each node described in the second graph structure data, the layout original data including the calculated layout position coordinate of each node is stored in the storage device 30 as the layout original data after updating with respect to the second graph structure data. Here, in the present embodiment, as described above, the layout original data includes hierarchy, order within the hierarchy and graphic definition information in addition to the layout position coordinate.

The graph display processing means 54 generates a graph based on the layout original data generated by the layout original data generating means 53 and the graph structure data associated with the layout original data and displays the graph on the screen of the display device 20. Particularly, when the layout original data generating means 53 generates the layout original data after updating, a graph for which data has been updated is generated based on the layout original data after updating and the second graph structure data associated with the layout original data after updating. When a graph for which data has been updated is generated, positional relationship of common nodes in the generated graph for which data has been updated becomes the same as the positional relationship in the graph corresponding to the first graph structure data with respect to the second graph structure data.

When the user gives an instruction to change layout of the graph displayed on the screen of the display device 20 instead of giving an instruction to update content of the graph structure data corresponding to the graph using the input device 10, the layout changing means 55 generates change data indicating content of the instructed change, stores the change data in the storage device 30 in association with the graph structure data corresponding to the graph, generates a graph for which the layout has been changed according to the instruction of the change and displays the graph on the screen of the display device 20. Examples of the instruction of change of layout include an instruction to change layout positions of nodes in the graph displayed on the screen of the display device 20, an instruction to change connection relationship of edges in the graph, and an instruction to add or eliminate nodes or edges in the graph. In this way, the graph generating device of the present embodiment is provided with a function for modifying a graph by changing the layout of the graph displayed on the screen of the display device 20. By this means, the user can easily change layout positions of the nodes or change connection relationship of edges in the graph displayed on the screen of the display device 20. It should be noted that, when layout of a given graph has been changed a plurality of times, a plurality of change data are stored in the storage device 30 in association with single graph structure data.

For example, to change a layout position of a given node, the user can drag and move the node to a desired position in the graph displayed on the screen of the display device 20 using a mouse. At this time, the layout changing means 55 generates a layout position coordinate of the moved node as change data. Further, to change a layout position of a node, the user can also input constraints indicating restrictions to content of the change. Such constraints include restrictions regarding hierarchy, restrictions regarding ordering within the hierarchy, or the like. Examples of the restrictions regarding hierarchy include restrictions that a given node should be disposed in particular hierarchy, and restrictions that one of two nodes should be disposed in hierarchy one order higher than the hierarchy in which the other node is disposed. Further, examples of the restrictions regarding ordering include restrictions that one of two nodes disposed in the same hierarchy should be disposed on the right of the other node. When the user inputs constraints, the layout changing means 55 generates restrictions of the constraints as change data. In this way, in the present embodiment, because the change data is stored in the storage device 30 in association with the graph structure data, this change data can be utilized in processing such as undo processing. For example, when the generated graph is restored once through processing such as undo processing from the graph for which layout has been changed and the same change is applied again, it is possible to reflect the change on the graph by utilizing this change data.

When receiving an instruction to change layout of the graph displayed on the screen of the display device 20 from the user and generating change data indicating content of the instructed change, the layout changing means 55 calculates a layout position of each node described in the graph structure data associated with the change data by executing processing according to Sugiyama algorithm based on the graph structure data under the conditions that change of the content indicated by the change data is applied on the graph, and generates a graph based on the calculated result. Particularly, in the present embodiment, the layout changing means 55 automatically generates a graph reflecting content of change which has been performed in the past by the user by utilizing the change data stored in the storage device 30. Specifically, when change data is generated, if other change data is associated with the graph structure data with which the change data this time is associated, the layout changing means 55 reads out the change data indicating content of the change applied in the past in addition to the change data indicating content of the change this time from the storage device 30 and calculates a layout position of each node described in the graph structure data by executing processing according to Sugiyama algorithm based on the graph structure data under the conditions that change of the content indicated by all the read change data is applied to the graph and generates a graph based on the calculated result. By this means, the user can easily obtain a graph reflecting the change of the layout performed in the past in addition to the change of the layout this time.

As described above, examples of the change data include data indicating position coordinates of nodes, data indicating connection relationship of edges, data indicating addition or elimination of nodes or edges, and data indicating restrictions regarding hierarchy and restrictions regarding ordering within the hierarchy. Among the change data, there is change data which makes the graph structure data corresponding to the graph for which layout has been changed according to the content of the change data different from the graph structure data corresponding to the graph before the layout has been changed. Therefore, in the present embodiment, when the layout changing means 55 judges that as a result of generating the graph for which layout has been changed according to the instruction of change from the user, the graph structure data corresponding to the graph for which layout has been changed becomes different from the graph structure data corresponding to the graph before layout has been changed, the layout changing means 55 generates graph structure data corresponding to the graph for which layout has been changed and stores the graph structure data in the storage device 30 as the first graph structure data. By this means, when layout is changed, if the graph structure data corresponding to the graph for which layout has been changed differs from the graph structure data corresponding to the graph before layout has been changed, because the layout changing means 55 can automatically generate the graph structure data corresponding to the latest graph after the layout has been changed, the user does not have to update the content of the graph structure data.

Next, procedure of processing of generating a graph based on graph structure data and displaying the graph on the screen of the display device 20 in the graph generating device of the present embodiment will be described.

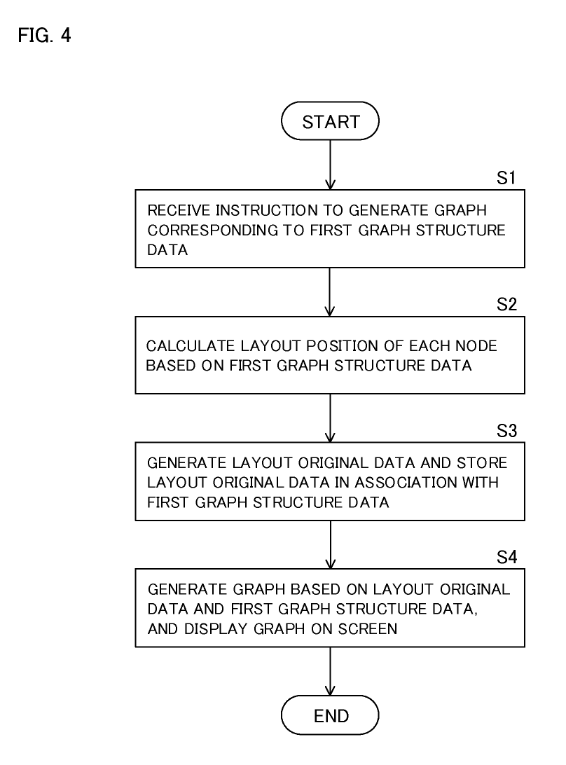

First, procedure of processing in a case where the user newly inputs graph structure data (first graph structure data) and a graph is generated based on the first graph structure data will be described. FIG. 4 is a flowchart for explaining procedure of processing of generating a graph based on the first graph structure data and displaying the graph on the screen of the display device 20 in the graph generating device of the present embodiment.

It is assumed that the user newly inputs graph structure data G1 illustrated in FIG. 2. This graph structure data G1 is not the second graph structure data but the first graph structure data. Further, according to node data of the first graph structure data G1 illustrated in FIG. 2, the graph includes 11 nodes 1 to 11, all of which have a shape of a circle having radius r. Further, according to edge data of the graph structure data G1, the graph includes 8 edges e1 to e8.

First, the user inputs an instruction to generate a graph corresponding to the first graph structure data G1 using the input device 10. When receiving this instruction (S1), the layout position calculating means 52 of the control unit 50 calculates a layout position of each of the nodes 1 to 11 described in the first graph structure data G1 by executing processing according to Sugiyama algorithm based on the first graph structure data G1 (S2).

Processing according to Sugiyama algorithm performed by the layout position calculating means 52 will be described in detail. As described above, Sugiyama algorithm is comprised of a hierarchy assigning step as the first step, an ordering step as the second step and a horizontal coordinate assignment step as the third step. First, the layout position calculating means 52 performs processing according to the hierarchy assigning step in Sugiyama algorithm. That is, the layout position calculating means 52 checks connection relationship between edges and nodes based on the edge data of the first graph structure data G1 illustrated in FIG. 2 and then assigns hierarchy in which each of the nodes 1 to 11 should be disposed so as to meet conditions that length of edges should be shortest, conditions that nodes should be consistent, or the like, as far as possible.

Specifically, the hierarchy is assigned as described below. According to the edge data illustrated in FIG. 2, because the node 1 is not connected to an end point of any edge, the node 1 is assigned to the first hierarchy which is the highest hierarchy. This node 1 is only connected to a starting point of the edge e1. While the node 3 is connected to the end point of the edge e1, because the node 3 is not connected to an end point of any edge other than the end point of the edge e1, the node 3 is assigned to hierarchy one order lower than the hierarchy of the node 1, that is, the second hierarchy. Further, the node 3 is connected to a starting point of the edge e2 and the starting point of the edge e3. While the node 5 is connected to the end point of the edge e2, because the node 5 is not connected to an end point of any edge other than the end point of the edge e2, the node 5 is assigned to hierarchy one order lower than the hierarchy of the node 3, that is, the third hierarchy. While the node 5 is connected to the starting point of the edge e4 and the node 8 is connected to an end point of the edge e4, because the node 8 is not connected to an endpoint of any edge other than the end point of the edge e4, the node 8 is assigned to the fourth hierarchy. Meanwhile, while the node 6 is connected to the end point of the edge e3, because the node 6 is not connected to an end point of any edge other than the end point of the edge e3, the node 6 is assigned to the third hierarchy.

Further, because the node 2 is not connected to an end point of any edge, the node 2 is assigned to the first hierarchy. While this node 2 is only connected to the starting point of the edge e5 and the node 4 is connected to the end point of the edge e5, because the node 4 is not connected to an end point of any edge other than the end point of the edge e5, the node 4 is assigned to the second hierarchy. Further, the node 4 is connected to the starting point of the edge e6 and the starting point of the edge e7. While the node 7 is connected to the end point of the edge e6, because the node 7 is not connected to an end point of any edge other than the end point of the edge e6, the node 7 is assigned to the third hierarchy. Meanwhile, while the node 11 is connected to the end point of the edge e7, because the node 11 is not connected to an endpoint of any edge other than the endpoint of the edge e7, the node 11 is assigned to the third hierarchy.

Further, because the node 9 is not connected to an end point of any edge, the node 9 is assigned to the first hierarchy. While the node 9 is only connected to the starting point of the edge e8 and the node 10 is connected to the end point of the edge e8, because the node 10 is not connected to an end point of any edge other than the end point of the edge e8, the node 10 is assigned to the second hierarchy. The hierarchy in which each node should be disposed is determined in this way.

Next, the layout position calculating means 52 performs processing according to the ordering step in Sugiyama algorithm. That is, the layout position calculating means 52 determines order for disposing each node to which the hierarchy has been assigned in each hierarchy so as to meet conditions that edges should be unidirectional, conditions that intersection number of edges should be smallest, or the like, as far as possible. Here, the order for disposing nodes in each hierarchy is expressed by a position in which the node is disposed from the left when all the nodes are arranged in a line. For example, it is determined that in the first hierarchy, the node 9 is disposed in the first position, the node 2 is disposed in the second position and the node 1 is disposed in the third position, in the second hierarchy, the node 10 is disposed in the first position, the node 4 is disposed in the second position and the node 3 is disposed in the third position, and, in the third hierarchy, the node 11 is disposed in the first position, the node 7 is disposed in the second position, the node 6 is disposed in the third position and the node 5 is disposed in the fourth position. Because only the node 8 is disposed in the fourth hierarchy, it is determined that the node 8 is disposed in the first position.

Next, the layout position calculating means 52 performs processing according to the horizontal coordinate assignment step in Sugiyama algorithm. That is, the layout position calculating means 52 determines a position of each node so as to meet conditions that edges should be vertical as far as possible and provides a layout position coordinate to the node. Here, for example, when the node has a shape of a circle, a position coordinate of the center can be used as the layout position coordinate, while, when the node has a shape of a rectangle, for example, a position coordinate of any corner (for example, the upper left corner) of four corners can be used as the layout position coordinate.

As described above, when the layout position calculating means 52 calculates a layout position coordinate of each of the nodes 1 to 11 by executing processing according to Sugiyama algorithm based on the first graph structure data G1 illustrated in FIG. 2, the layout original data generating means 53 generates layout original data L1 illustrated in FIG. 3 based on the data obtained through the processing by the layout position calculating means 52 (S3). The layout original data L1 is intermediate data utilized for generating a graph. The layout original data L1 includes data for each node such as hierarchy assigned to the node, the order for disposing the node within the hierarchy (order within the hierarchy), the layout position coordinate and the graphic definition information. The layout original data generating means 53 stores the generated layout original data L1 in the storage device 30 in association with the first graph structure data G1.

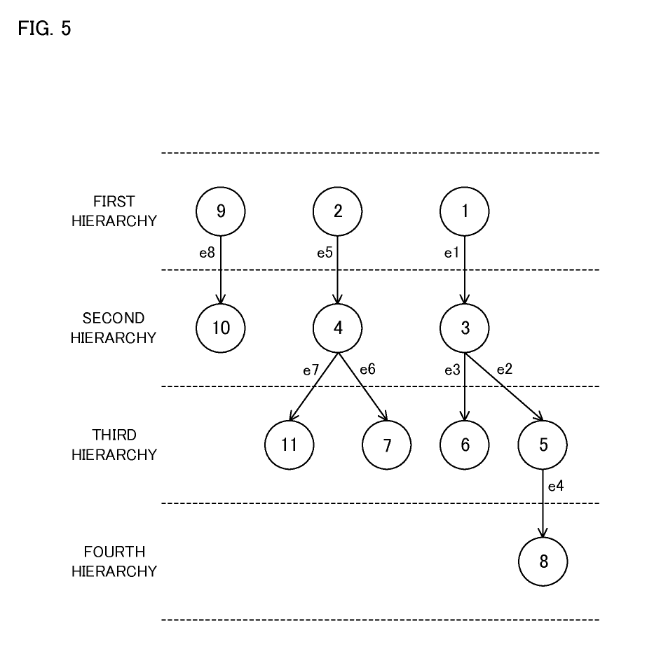

Subsequently, the graph display processing means 54 generates a graph based on the layout original data L1 generated by the layout original data generating means 53 and the first graph structure data G1 associated with the layout original data L1 and displays the graph on the screen of the display device 20 (S4). FIG. 5 illustrates the graph generated based on the layout original data L1 illustrated in FIG. 3 and the first graph structure data G1 illustrated in FIG. 2. The graph illustrated in FIG. 5 is displayed on the screen of the display device 20. Here, when a graph is generated, connection points with edges on the nodes are determined in advance. When a node in given hierarchy is connected to a node in hierarchy one order lower than the given hierarchy through an edge, a graph is generated by connecting connection points of these two nodes with an arrowed line. The processing for generating a graph corresponding to the first graph structure data G1 is finished.

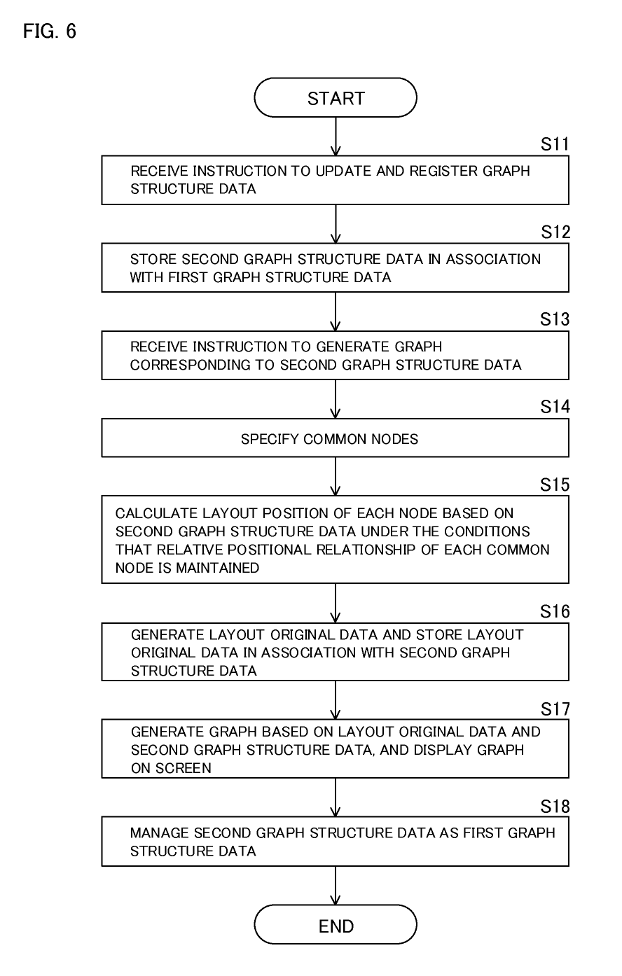

Next, procedure of processing in a case where the user gives an instruction to update content of the first graph structure data G1 and a graph is generated based on the second graph structure data reflecting content of the instructed updating will be described. FIG. 6 is a flowchart for explaining procedure of processing of generating a graph based on the second graph structure data and displaying the graph on the screen of the display device 20 in the graph generating device of the present embodiment.

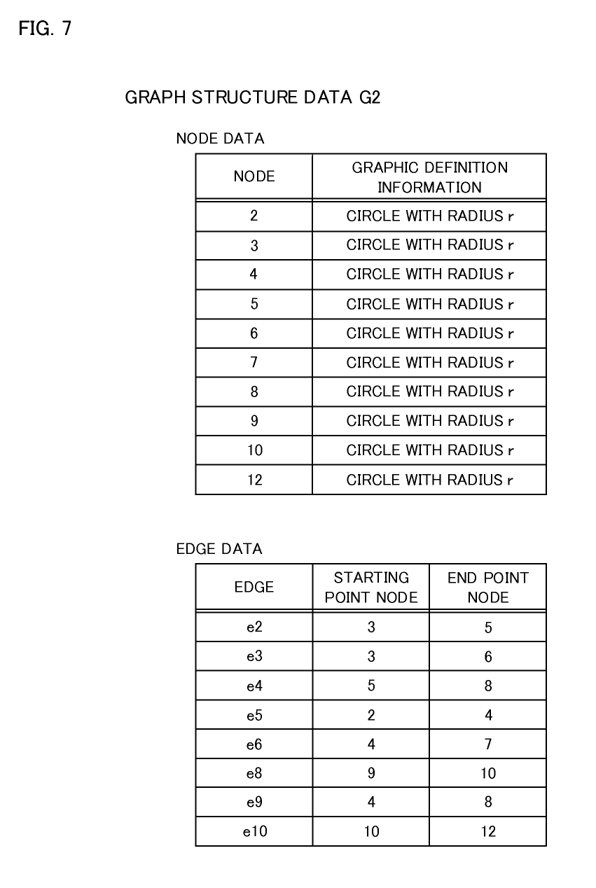

In this case, first, the user selects the first graph structure data G1 and causes a graph corresponding to the first graph structure data G1 to be displayed on the screen of the display device 20. Next, the user clicks on a predetermined updating button and causes an entry screen for graph structure data to be displayed. The user newly inputs the graph structure data after updating (second graph structure data) on the entry screen. FIG. 7 is a diagram illustrating an example of the second graph structure data G2 with respect to the first graph structure data G1 in FIG. 2. The second graph structure data G2 illustrated in FIG. 7 is obtained by “eliminating the node 1”, “eliminating the node 11”, and “adding the node 12” in the first graph structure data G1 illustrated in FIG. 2. At this time, in association with elimination of the nodes 1 and 11 and addition of the node 12, also concerning edges, “the edge e1 is eliminated”, “the edge e7 is eliminated”, “the edge e9 is added” and “the edge e10 is added”. Here, the starting point node of the edge e9 is the node 4, and the end point node of the edge e9 is the node 8. Further, the starting point node of the edge e10 is the node 10 and the end point node of the edge e10 is the node 12. After the user finishes inputting, the user clicks on an updating and registering button for giving an instruction to update and register the graph structure data. When receiving this instruction (S11), the data updating and registering means 51 stores the input second graph structure data G2 in the storage device 30 in association with the first graph structure data G1 (S12).

Next, the user inputs an instruction to generate a graph corresponding to the second graph structure data G2 using the input device 10. When receiving the instruction to generate a graph corresponding to the second graph structure data G2 (S13), the layout position calculating means 52 specifies nodes described common to the second graph structure data G2 and the first graph structure data G1 associated with the second graph structure data G2 as common nodes (S14). In this case, the nodes 2 to 10 are specified as the common nodes.

Next, the layout position calculating means 52 calculates a layout position of each of the nodes 2 to 10 and 12 described in the second graph structure data G2 by executing processing according to Sugiyama algorithm based on the second graph structure data G2 under the conditions that concerning each of the specified common nodes 2 to 10, relative positional relationship defined by the layout original data (layout original data before updating) L1 stored in the storage device 30 in association with the first graph structure data G1 is maintained (S15). In this way, by imposing the above-described conditions, in the processing by the layout position calculating means 52, relative positional relationship of each of the common nodes 2 to 10 indicated in the layout original data L1 before updating illustrated in FIG. 3 is maintained as it is.

Here, processing of step S15 performed by the layout position calculating means 52 will be described in detail. First, the layout position calculating means 52 performs processing according to the hierarchy assigning step in Sugiyama algorithm. In the processing according to the hierarchy assigning step, hierarchy is assigned so that hierarchy in which each of the common nodes 2 to 10 should be disposed is the same as hierarchy indicated in the layout original data L1 before updating in illustrated in FIG. 3. That is, it is determined that the common nodes 2 and 9 are disposed in the first hierarchy, the common nodes 3, 4 and 10 are disposed in the second hierarchy, the common nodes 5, 6 and 7 are disposed in the third hierarchy, and the common node 8 is disposed in the fourth hierarchy. Further, concerning the newly added node 12, after connection relationship between the edges and the nodes is checked based on the edge data of the second graph structure data G2, hierarchy in which the node 12 should be disposed is assigned so as to meet the conditions that length of edges should be shortest, conditions that nodes should be consistent, or the like, as far as possible. Because the node 12 is only connected to the end point of the edge e10, the node 12 is assigned to hierarchy one order lower than the hierarchy of the node 10 which is the starting point node of the edge e10, that is, to the third hierarchy.

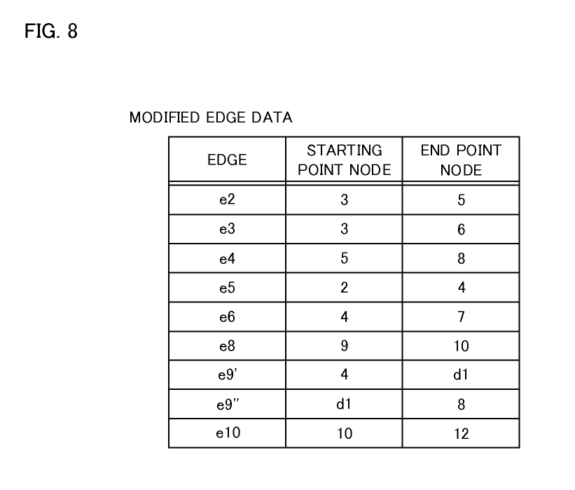

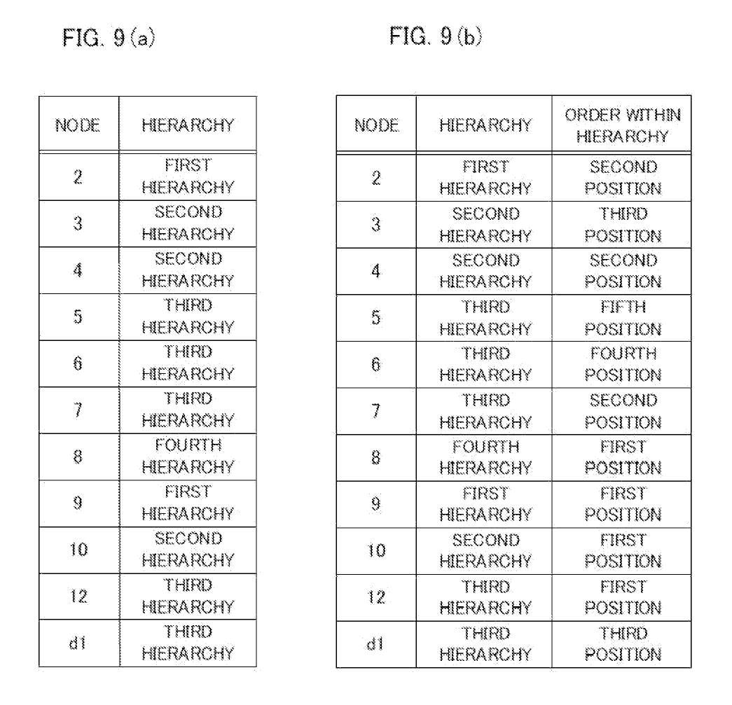

When there is one or more hierarchy between the hierarchy assigned to the node connecting the starting point of a given edge and hierarchy assigned to the node connecting the end point of the given edge, the layout position calculating means 52 adds a dummy node for indicating a pass point of the edge to each of the hierarchy located therebetween. According to the edge data of the second graph structure data G2, while the node 4 is connected to the starting point of the edge e9, and the node 8 is connected to the end point of the edge e9, as a result of the processing according to the above-described hierarchy assigning step, the node 4 is assigned to the second hierarchy, and the node 8 is assigned to the fourth hierarchy. Therefore, a dummy node d1 is added to the third hierarchy. Further, addition of the dummy node d1 separates the edge e9 into the edge e9′ connecting the node 4 and the dummy node d1, and the edge e9″ connecting the dummy node d1 and the node 8. Here, the layout position calculating means 52 modifies the edge data according to the addition of the dummy node when the dummy node is added and stores the modified edge data in the storage device 30 as the modified edge data. FIG. 8 illustrates an example of the modified edge data which has been modified by the layout position calculating means 52. FIG. 9(a) illustrates hierarchy of each of the nodes 2 to 10, 12 and d1 determined when the layout position calculating means 52 performs processing according to the hierarchy assigning step.

Next, the layout position calculating means 52 performs processing according to the ordering step in Sugiyama algorithm. Here, when there is a dummy node, ordering of the dummy node is also performed. In the processing according to the ordering step, ordering is performed so that concerning the common nodes 2 to 10 other than the node added when data is updated among all the nodes, order for disposing each common node assigned to each hierarchy becomes the same order indicated in the layout original data L1 illustrated in FIG. 3. That is, it is determined that in the first hierarchy, the common node 9 is disposed in the first position, and the common node 2 is disposed in the second position, and, in the second hierarchy, the common node 10 is disposed in the first position, the common node 4 is disposed in the second position and the common node 3 is disposed in the third position. Meanwhile, in the third hierarchy, the common nodes 5, 6 and 7, the newly added node 12, and the dummy node d1 are assigned. In this case, first, assuming that only the common nodes 5, 6 and 7 are assigned to the third hierarchy, it is temporarily determined that the common node 7 is disposed in the first position, the common node 6 is disposed in the second position and the common node 5 is disposed in the third position based on the content of the layout original data L1 before updating illustrated in FIG. 3. Then, order for disposing the node 12 and the dummy node dl in the third hierarchy in which the order of the common nodes 5, 6 and 7 is temporarily determined as described above is determined so as to meet conditions that edges should be unidirectional, conditions that intersection number of edges should be smallest, or the like, as far as possible. In this way, for example, it is finally determined that in the third hierarchy, the node 12 is disposed in the first position, the common node 7 is disposed in the second position, the dummy node d1 is disposed in the third position, the common node 6 is disposed in the fourth position, and the common node 5 is disposed in the fifth position. Further, in the fourth hierarchy, because only the common node 8 is disposed, it is determined that the common node 8 is disposed in the first position. FIG. 9(b) illustrates hierarchy of each of the nodes 2 to 10, 12 and dl and the order within the hierarchy determined when the layout position calculating means 52 performs processing according to the ordering step as described above.

Next, the layout position calculating means 52 performs processing according to the horizontal coordinate assignment step in Sugiyama algorithm. That is, a position of each node including a dummy node is determined so as to meet the conditions that edges should be vertical as far as possible and a layout position coordinate of each node is calculated. Here, when there is a dummy node, a layout position coordinate is also provided to the dummy node. Actually, it is determined in advance that the dummy node has a shape of a predetermined figure, for example, a point, so that it is possible to use a position coordinate of the point as the layout position coordinate for the dummy node.

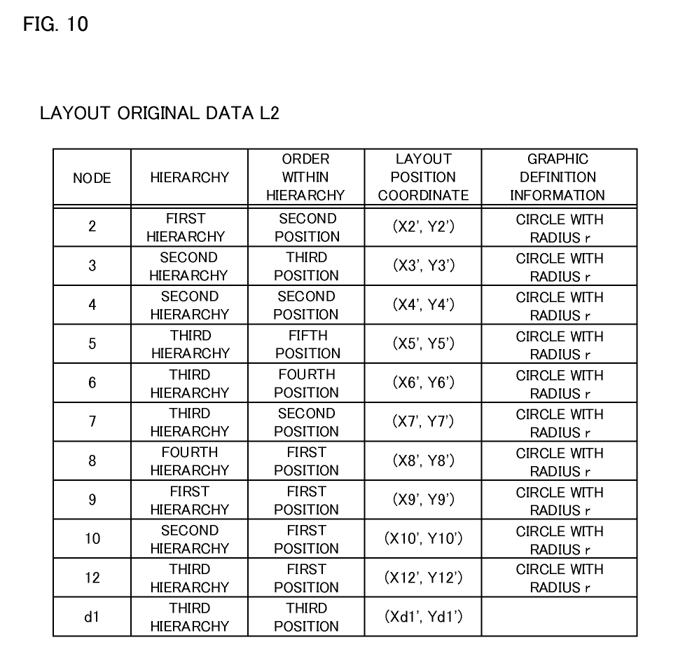

When the layout position calculating means 52 calculates a layout position coordinate of each of the nodes 2 to 10, 12 and d1 as described above by executing the processing according to Sugiyama algorithm based on the second graph structure data G2 illustrated in FIG. 7 under the conditions that relative positional relationship of each of the common nodes 2 to 10 is maintained, the layout original data generating means 53 generates layout original data for laying out each of the nodes 2 to 10, 12 and d1 based on the data obtained through the processing by the layout position calculating means 52 (S16). FIG. 10 is a diagram illustrating an example of the layout original data (layout original data after updating) L2 with respect to the second graph structure data G2 illustrated in FIG. 7. Here, because the shape and the size of the dummy node are determined in advance, graphic definition information of the dummy node d1 is not indicated in the layout original data L2. The layout original data generating means 53 stores the generated layout original data L2 in the storage device 30 in association with the second graph structure data G2.

Subsequently, the graph display processing means 54 generates a graph based on the layout original data L2 after updating generated by the layout original data generating means 53 and the second graph structure data G2 illustrated in FIG. 7 and displays the graph on the screen of the display device 20 (S17). Here, when the graph is generated, concerning the dummy node, a point which is a figure indicating the dummy node becomes a connection point with an edge. Further, after the processing in step S17, the control unit 50 provides a new identification ID to the second graph structure data G2 and manages the second graph structure data G2 as the first graph structure data (S18). At this time, it is also possible to delete the first graph structure data (graph structure data before updating) G1 with respect to the second graph structure data G2. That is, it is also possible to store only the latest graph structure data in the storage device 30 after the processing of modifying the graph through updating of data. The processing for generating the graph corresponding to the second graph structure data G2 is finished.

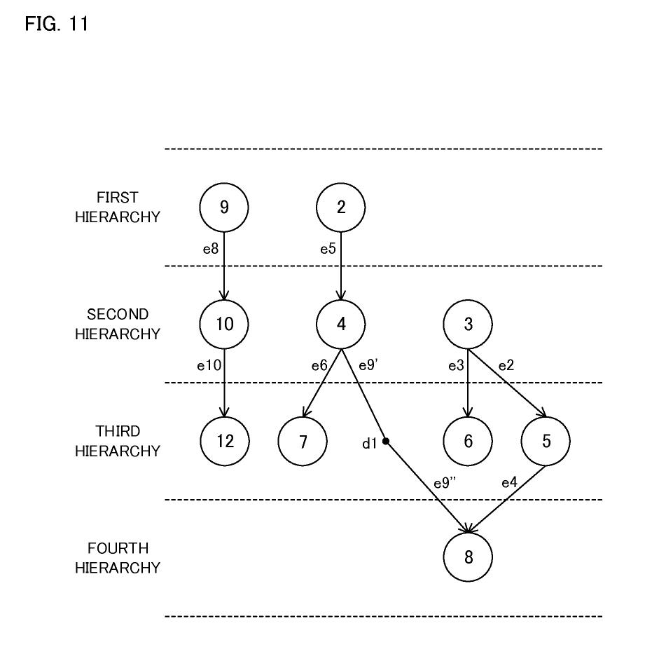

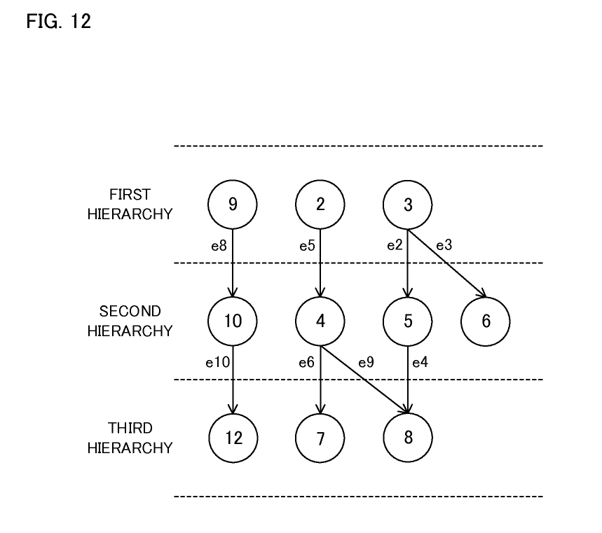

FIG. 11 illustrates an example of a graph generated by the graph display processing means 54 based on the layout original data L2 after updating and the second graph structure data G2. Here, in the present embodiment, while a dummy node is expressed with a point as described above, in the graph illustrated in FIG. 11, to clarify that there is a dummy node, the dummy node is expressed with a black circle (small circle). In this graph illustrated in FIG. 11, the common nodes 2 to 10 are laid out so as to have the same positional relationship as the positional relationship in the graph before the data has been updated illustrated in FIG. 5. Meanwhile, FIG. 12 illustrates an example of the graph generated by executing the processing according to Sugiyama algorithm based on the graph structure data G2 illustrated in FIG. 7 using the conventional graph generating device. That is, the graph illustrated in FIG. 12 is generated without utilizing the layout original data L1 associated with the graph structure data G1 before updating. In this graph illustrated in FIG. 12, the positional relationship of the common nodes 2 to 10 is different from the positional relationship in the graph illustrated in FIG. 11, and, thus, different from the positional relationship in the graph before the data has been updated illustrated in FIG. 5. Specifically, in the graph illustrated in FIG. 12, the common node 3 is disposed in the first hierarchy, the common nodes 5 and 6 are disposed in the second hierarchy, and the common node 8 is disposed in the third hierarchy. Therefore, in order to dispose the common nodes 3, 5, 6 and 8 so as to have the same positional relationship as the positional relationship in the graph before the data has been updated illustrated in FIG. 5, the user has to substantially change the content of the graph illustrated in FIG. 12. On the other hand, if a graph corresponding to the second graph structure data G2 is generated using the graph generating device of the present embodiment, as illustrated in FIG. 11, because the common nodes 2 to 10 can be disposed so as to have the same positional relationship as the positional relationship in the graph before the data has been updated illustrated in FIG. 5, the user does not have to change the layout of the common nodes 2 to 10, which can save bother.

It should be noted that when a graph corresponding to the second graph structure data is generated, the graph generating device of the present embodiment performs layout of the graph under the conditions that concerning each common node, relative positional relationship defined by the layout original data before updating associated with the first graph structure data is maintained. Therefore, in the present embodiment, there is a case where a starting point node and an end point node of a given edge may be disposed in the same hierarchy depending on the content of the second graph structure data. There is also a case where an end point node of a given edge may be disposed in the hierarchy higher order than the hierarchy in which a starting point node of the given edge is disposed depending on the content of the second graph structure data.

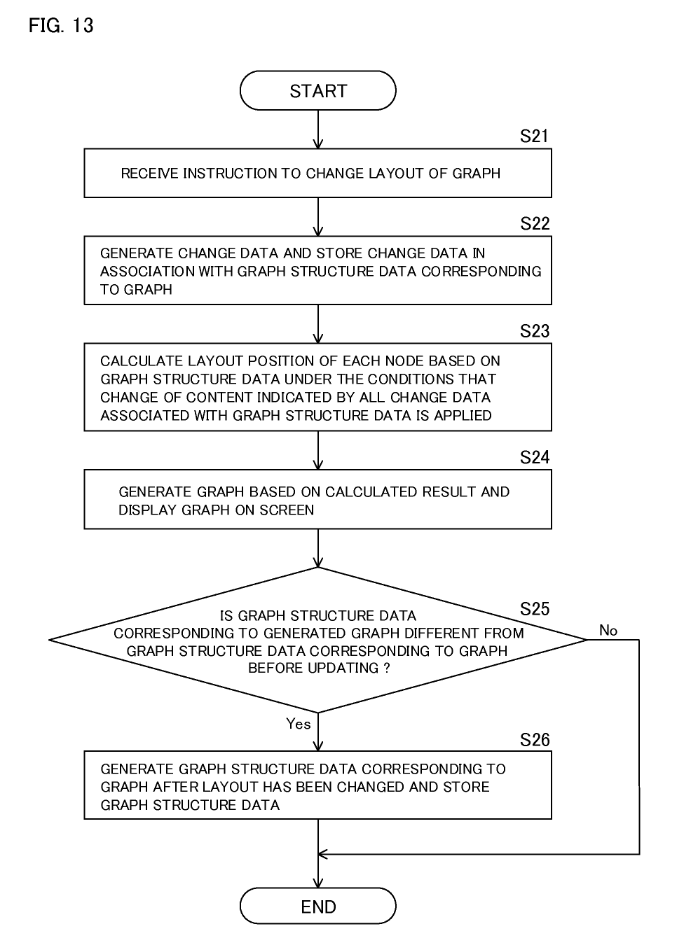

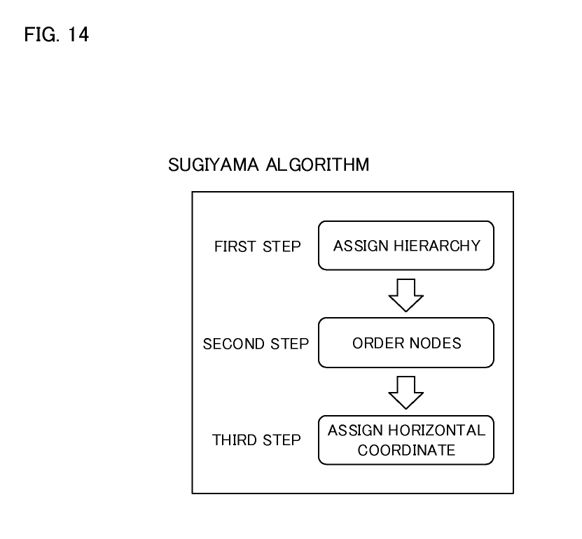

Next, procedure of processing of generating a graph and displaying the graph on the screen of the display device 20 when an instruction to change layout is given in the graph generating device of the present embodiment will be described. FIG. 13 is a flowchart for explaining procedure of the processing of generating a graph and displaying the graph on the screen of the display device 20 when the instruction to change layout is given in the graph generating device of the present embodiment.

The user examines content of the graph, for example, whether each node is appropriately disposed by viewing the graph displayed on the screen of the display device 20. If the user considers that, for example, a layout position of a node, connection relationship of edges, or the like, should be changed, the user changes the layout of the graph. For example, the user gives an instruction to change the layout position of the node or connection relationship of edges in the graph displayed on the screen of the display device 20 using the input device 10. When receiving the instruction to change the layout of the graph (S21), the layout changing means 55 generates change data indicating content of the instructed change and stores the generated change data in the storage device 30 in association with the graph structure data corresponding to the graph (S22).

Next, the layout changing means 55 reads out all the change data associated with the graph structure data with which the generated change data is associated from the storage device 30, and calculates a layout position of each node described in the graph structure data by executing processing according to Sugiyama algorithm based on the graph structure data under the conditions that change of content indicated by all the read change data is applied to the graph (S23). The layout changing means 55 generates a graph based on the calculated result and displays the graph on the screen of the display device 20 (S24). The graph after the layout has been changed generated in this way reflects all the content of the change performed in the past.

Then, the layout changing means 55 judges whether or not, as a result of generating the graph through the processing in step S24, the graph structure data corresponding to the generated graph after the layout has been changed differs from the graph structure data corresponding to the graph before the layout has been changed (S25). If the judgment in step S25 is negative, the layout changing means 55 finishes processing flow according to the flow illustrated in FIG. 13. On the other hand, if the judgment in step S25 is positive, the layout changing means 55 newly generates graph structure data corresponding to the graph after the layout has been changed and stores the graph structure data in the storage device 30 as the first graph structure data (S26). By this means, the user does not have to update the content of the graph structure data. Then, the layout changing means 55 finishes processing according to the flow illustrated in FIG. 13.

When a graph after data has been updated is generated, the graph generating device of the present embodiment specifies nodes described common to the second graph structure data and the first graph structure data with respect to the second graph structure data as common nodes, and performs layout of the graph by executing processing according to Sugiyama algorithm based on the second graph structure data under the conditions that concerning each of the specified common nodes, relative positional relationship defined by the layout original data for the generated graph corresponding to the first graph structure data is maintained. Therefore, a position of each common node to be laid out on the graph can be easily determined based on the layout original data for the generated graph, so that it is possible to substantially reduce load of the processing when generating a graph after data has been updated. Moreover, in the graph after data has been updated, each common node can be laid out so as to have the same positional relationship as the positional relationship in the generated graph.

Further, the graph generating device of the present embodiment includes a layout changing means which, when the user gives an instruction to change layout of the graph displayed on the screen of the display device using the input device instead of giving an instruction to update content of the graph structure data corresponding to the graph, generates change data indicating content of the instructed change, stores the change data in the storage device in association with the graph structure data corresponding to the graph, generates a graph for which the layout has been changed according to the instruction of the change and displays the graph on the screen of the display device. By this means, because the change data can be utilized in processing such as undo processing, when, for example, the generated graph is restored once through processing such as undo processing from the graph for which the layout has been changed and the same change is applied again, it is possible to reflect the change on the graph by utilizing this change data.

Further, in the graph generating device according to the present invention, when the change data has been generated, because the layout changing means calculates a layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result, the user can easily obtain a graph also reflecting the change of the layout performed in the past in addition to the change of the layout this time.

It should be noted that the present invention is not limited to the above-described embodiment, and various modification is possible within the scope of the gist of the present invention.

While a case has been described in the above-described embodiment where a graph with a small number of nodes is generated to simplify the explanation, the graph generating device, the graph generating method and the graph generating program of the present invention can be also applied to a case where a graph with thousands or tens of thousands of nodes is generated. Actually, the graph generating device, the graph generating method and the graph generating program of the present invention can be applied to a case where various graphs such as a call graph indicating call relationship between subroutines of a system program, a graph indicating equipment configuration on a network or organizational structure of an enterprise, or the like, are generated.

Further, while a case has been described in the above-described embodiment where Sugiyama algorithm is used as a graph layout algorithm, the graph layout algorithm used in the present invention is not limited to Sugiyama algorithm.

Further, while a case has been described in the above-described embodiment where a directed acyclic graph is generated, the graph generating device, the graph generating method and the graph generating program of the present invention can be also applied to, for example, a case where a directed cyclic graph is generated and a case where a graph other than a directed graph is generated.

### INDUSTRIAL APPLICABILITY

As described above, according to the graph generating device, the graph generating method and the graph generating program of the present invention, when a graph for which data has been updated is generated, positions of common nodes described common to the second graph structure data and the first graph structure data with respect to the second graph structure data, to be laid out on the graph can be easily determined based on the layout original data for the generated graph corresponding to the first graph structure data, so that it is possible to substantially reduce load of processing for generating a graph for which data has been updated. Moreover, in this graph for which data has been updated, each of the common nodes can be laid out so as to have the same positional relationship as the positional relationship in the generated graph. Therefore, the present invention can be used in a case where, for example, a large-scale call graph is generated and displayed on a screen of display means in system development.

### DESCRIPTION OF THE REFERENCE NUMERAL

10 Input device (input means)
20 Display device (display means)
30 Storage device (storage means)
50 Control unit (control means)
51 Data updating and registering means
52 Layout position calculating means
53 Layout original data generating means
54 Graph display processing means
55 Layout changing means

1. A graph generating device generating a graph including a plurality of nodes and a plurality of edges connecting the nodes based on graph structure data including data indicating a shape and a size of each node and data indicating connection relationship to the nodes for each edge, and displaying the graph on a screen of a display unit, the graph generating device comprising:
a storage unit in which the graph structure data corresponding to the generated graph is stored as first graph structure data and layout original data including data relating to a layout position of each node described in the first graph structure data is stored, the layout original data being generated when processing according to a predetermined graph layout algorithm is executed based on the first graph structure data for generating the graph;
a data updating and registering unit that, when a user gives an instruction to update content of the first graph structure data corresponding to the generated graph using an input unit, stores and registers the new graph structure data reflecting content of the instructed updating in the storage unit as second graph structure data with respect to the first graph structure data;
a layout position calculating unit that specifies nodes described common to the second graph structure data registered by the data updating and registering unit and the first graph structure data with respect to the second graph structure data as common nodes and calculates a layout position of each node described in the second graph structure data by executing processing according to the graph layout algorithm based on the second graph structure data under the conditions that concerning each of the specified common nodes, relative positional relationship defined by the layout original data including data relating to the layout position of each node described in the first graph structure data is maintained;
a layout original data generating unit that generates the layout original data including data relating to the layout position of each node described in the second graph structure data, the layout position of each node being calculated by the layout position calculating unit, and stores the generated layout original data in the storage unit as layout original data after updating with respect to the second graph structure data; and
a graph display processing unit that generates a graph based on the layout original data after updating and the second graph structure data with respect to the layout original data after updating and displays the graph on the screen of the display unit.

2. The graph generating device according to claim 1, further comprising a layout changing unit that, when the user gives an instruction to change layout of the graph displayed on the screen of the display unit using the input unit, generates change data indicating content of the instructed change, stores the change data in the storage unit in association with the graph structure data corresponding to the graph, generates a graph for which the layout has been changed according to the instruction of the change and displays the generated graph on the screen of the display unit.

3. The graph generating device according to claim 2, wherein, when the change data has been generated, the layout changing unit calculates a layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result.

4. The graph generating device according to claim 2, wherein, when it is judged that as a result of generating the graph for which the layout has been changed according to the instruction of the change from the user, the graph structure data corresponding to the graph for which the layout has been changed differs from the graph structure data corresponding to the graph before the layout has been changed, the layout changing unit newly generates the graph structure data corresponding to the graph for which the layout has been changed and stores the newly generated graph structure data in the storage unit as the first graph structure data.

5. A graph generating method for generating a graph including a plurality of nodes and a plurality of edges connecting the nodes based on graph structure data including data indicating a shape and a size of each node and data indicating connection relationship to the nodes for each edge by utilizing a computer, and displaying the graph on a screen of a display unit of the computer,
when the computer comprises a storage unit in which the graph structure data corresponding to the generated graph is stored as first graph structure data and layout original data including data relating to a layout position of each node described in the first graph structure data is stored, the layout original data being generated when processing according to a predetermined graph layout algorithm is executed based on the first graph structure data for generating the graph, and a control unit that performs processing for generating the graph,
the graph generating method comprising:
a data updating and registering step of, when a user gives an instruction to update content of the first graph structure data corresponding to the generated graph using an input unit of the computer, the control unit storing and registering the new graph structure data reflecting content of the instructed updating in the storage unit as second graph structure data with respect to the first graph structure data;
a layout position calculating step of the control unit specifying nodes described common to the second graph structure data registered in the data updating and registering step and the first graph structure data with respect to the second graph structure data as common nodes, and calculating a layout position of each node described in the second graph structure data by executing processing according to the graph layout algorithm based on the second graph structure data under the conditions that concerning each of the specified common nodes, relative positional relationship defined by the layout original data including data relating to the layout position of each node described in the first graph structure data is maintained;
a layout original data generating step of the control unit generating the layout original data including data relating to the layout position of each node described in the second graph structure data, the layout positon of each node being calculated in the layout position calculating step, and storing the generated layout original data in the storage unit as layout original data after updating with respect to the second graph structure data; and
a graph display processing step of the control unit generating a graph based on the layout original data after updating and the second graph structure data with respect to the layout original data after updating and displaying the graph on the screen of the display unit.

6. The graph generating method according to claim 5, further comprising a layout changing step of, when the user gives an instruction to change layout of the graph displayed on the screen of the display unit using the input unit, the control unit generating change data indicating content of the instructed change, storing the change data in the storage unit in association with the graph structure data corresponding to the graph, generating a graph for which the layout has been changed according to the instruction of the change and displaying the generated graph on the screen of the display unit.

7. The graph generating method according to claim 6, wherein, in the layout changing step, when the change data has been generated, the control unit calculates a layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result.

8. The graph generating method according to claim 6, wherein, in the layout changing step, when the control unit judges that as a result of generating the graph for which the layout has been changed according to the instruction of the change from the user, the graph structure data corresponding to the graph for which the layout has been changed differs from the graph structure data corresponding to the graph before the layout has been changed, the control unit newly generates the graph structure data corresponding to the graph for which the layout has been changed and stores the newly generated graph structure data in the storage unit as the first graph structure data.

9. A graph generating program for generating a graph including a plurality of nodes and a plurality of edges connecting the nodes based on graph structure data including data indicating a shape and a size of each node and data indicating connection relationship to the nodes for each edge by utilizing a computer, and displaying the graph on a screen of a display unit of the computer,
when the computer comprises a storage unit in which the graph structure data corresponding to the generated graph is stored as first graph structure data and layout original data including data relating to a layout position of each node described in the first graph structure data is stored, the layout original data being generated when processing according to a predetermined graph layout algorithm is executed based on the first graph structure data for generating the graph,
the graph generating program causing the computer to implement:
a data updating and registering function of, when a user gives an instruction to update content of the first graph structure data corresponding to the generated graph using an input unit of the computer, storing and registering the new graph structure data reflecting content of the instructed updating in the storage unit as second graph structure data with respect to the first graph structure data;
a layout position calculating function of specifying nodes described common to the second graph structure data registered by the data updating and registering function and the first graph structure data with respect to the second graph structure data as common nodes, and calculating a layout position of each node described in the second graph structure data by executing processing according to the graph layout algorithm based on the second graph structure data under the conditions that concerning each of the specified common nodes, relative positional relationship defined by the layout original data including data relating to the layout position of each node described in the first graph structure data is maintained;
a layout original data generating function of generating the layout original data including data relating to the layout position of each node described in the second graph structure data, the layout positon of each node being calculated by the layout position calculating function, and storing the generated layout original data in the storage unit as layout original data after updating with respect to the second graph structure data; and
a graph display processing function of generating a graph based on the layout original data after updating and the second graph structure data with respect to the layout original data after updating and displaying the graph on the screen of the display unit.

10. The graph generating program according to claim 9, causing the computer to further implement a layout changing function of, when the user gives an instruction to change layout of the graph displayed on the screen of the display unit using the input unit, generating change data indicating content of the instructed change, storing the change data in the storage unit in association with the graph structure data corresponding to the graph, generating a graph for which the layout has been changed according to the instruction of the change and displaying the generated graph on the screen of the display unit.

11. The graph generating program according to claim 10, wherein, when the change data has been generated, the layout changing function calculates the layout position of each node described in the graph structure data with which the generated change data is associated by executing processing according to the graph layout algorithm based on the graph structure data under the conditions that change of content indicated by all the change data associated with the graph structure data is applied to the graph, and generates a graph based on the calculated result.

12. The graph generating program according to claim 10, wherein, when it is judged that as a result of generating the graph for which the layout has been changed according to the instruction of the change from the user, the graph structure data corresponding to the graph for which the layout has been changed differs from the graph structure data corresponding to the graph before the layout has been changed, the layout changing function newly generates the graph structure data corresponding to the graph for which the layout has been changed and stores the newly generated graph structure data in the storage unit as the first graph structure data.
